(19) United States
(12) Patent Application Publication
(10) Pub. No.: US 2026/0105105 A1
(43) Pub. Date: Apr. 16, 2026

(54) ELECTRONIC DEVICE AND METHOD FOR PROVIDING INFORMATION IN ELECTRONIC DEVICE

(71) Applicants: HYUNDAI MOTOR COMPANY, Seoul (KR); Kia Corporation, Seoul (KR)

(72) Inventors: Seung Uk BAIK, Hwaseong-si (KR); Su Yeong LEE, Hwaseong-si (KR); Wan Jae SHIN, Hwaseong-si (KR); Jung Woo LIM, Hwaseong-si (KR)

(21) Appl. No.: 19/232,242

(22) Filed: Jun. 9, 2025

(30) Foreign Application Priority Data
Oct. 10, 2024 (KR) 10-2024-0137900

(51) Int. Cl. G06F 16/906; G06F 16/901; G06F 16/93; G06F 40/166

(52) U.S. Cl. CPC G06F 16/906; G06F 16/901; G06F 16/93; G06F 40/166

(57) ABSTRACT

An electronic device includes a memory storing computer-executable instructions and at least one processor that accesses the memory and executes the instructions. The at least one processor stores a document including at least one word, metadata of the document, and classification information of the document, based on that an identifier of the document is a primary key, applies a regular expression for identifying a section included in the document to the document to obtain a target paragraph included in the document, and outputs the document in response to an input of a user, based on a feature vector of the target paragraph and the input of the user.

### CROSS-REFERENCE TO RELATED APPLICATION

This application claims the benefit of priority to Korean Patent Application No. 10-2024-0137900, filed in the Korean Intellectual Property Office on Oct. 10, 2024, the entire contents of which are incorporated herein by reference.

### TECHNICAL FIELD

The present disclosure relates to an electronic device and a method for providing information, and more particularly, relates to technologies for reducing hallucination of a large language model (LLM).

### BACKGROUND

Conventional generative artificial intelligence (AI) requires significant time, high costs, and extensive datasets for model training. Furthermore, security concerns, such as input data logging or reutilization for model training, limit the practical use of generative AI in corporate environments. Additionally, because generative AI generates responses based on data available up to its training time, it may struggle to provide answers incorporating the most recent information.

Attempts have been made to develop AI solutions for an engineering problem. While conventional universal models can generate broad solutions, they often lack the specificity required from a domain expert's perspective. Furthermore, since these models can only reflect information available at the time of training, they may fail to provide an answer incorporating the latest developments. Notably, generative AI relies on probability-based token generation, which can lead to hallucination, where the model generates false or misleading information, making it difficult to verify the accuracy of its responses.

To address these challenges, there is a need for technologies for reducing hallucination in a large language model (LLM).

### SUMMARY

The present disclosure is directed to an electronic device for storing metadata of a document and classification information of the document in a database on the basis of an identifier of the document to provide an answer including the most recent information based on information included in the database, without additional training of a large language model, which requires high cost and significant time, and a method for providing information in the electronic device.

The present disclosure is also directed to an electronic device for determining classification information, based on an object identified from contents included in a document and an action corresponding to the object to reduce hallucination to increase reliability of an answer and provide an answer which is easy to compare other types of technologies for the same purpose in the same technology field and a method for providing information in the electronic device.

According to an aspect of the present disclosure, an electronic device can include a memory storing computer-executable instructions and at least one processor that accesses the memory and executes the instructions. The at least one processor can store a document including at least one word, metadata of the document, and classification information of the document, based on that an identifier of the document is a primary key, apply a regular expression for identifying a section included in the document to the document to obtain a target paragraph included in the document, and output the document in response to an input of a user, based on a feature vector of the target paragraph and the input of the user.

In some implementations, the at least one processor can determine the classification information, based on an object identified from contents included in the document and an action corresponding to the object, identify the metadata, including description information of the document, from a server in which the document is stored, and store the document, the metadata, and the classification information in a database for storing data with the identifier as the primary key.

In some implementations, the at least one processor can apply the regular expression to the document to identify a target section included in the document and about an abstract of the document or contents included in the document and obtain the feature vector of the target paragraph, based on that a paragraph corresponding to the target section is the target paragraph.

In some implementations, the at least one processor can receive the input of the user, the input including object classification information, a question, and a search weight, from the user.

In some implementations, the at least one processor can identify a type of the question from the input of the user and determine whether the question included in the input of the user is an academic question.

In some implementations, the at least one processor can determine at least one large language model (LLM) output generated from an LLM as an output corresponding to the input of the user.

In some implementations, the at least one processor can obtain a comparison vector about a feature of the question, based on that the question is the academic question and that the object classification information and the classification information of the document are the same as each other.

In some implementations, the at least one processor can identify at least one elementary vector from a vector store in which the feature vector is stored, determine a similarity of each of the at least one elementary vector, based on comparison between the comparison vector and the at least one elementary vector, and output the document in response to the input of the user, based on that a vector with a highest similarity among the at least one elementary vector is the feature vector.

In some implementations, the at least one processor can apply the search weight to the similarity of each of the at least one elementary vector and output the document in response to the input of the user, based on the similarity of each of the at least one elementary vector, the similarity to which the search weight is applied.

In some implementations, the at least one processor can obtain a rouge score about at least one LLM output obtained by applying a question included in the input of the user to an LLM, based on that the document is determined as an output corresponding to the input of the user, and perform comparison between the rouge score and a predetermined value to verify validation of the output.

According to another aspect of the present disclosure, a method can include storing a document including at least one word, metadata of the document, and classification information of the document, based on that an identifier of the document is a primary key, applying a regular expression for identifying a section included in the document to the document to obtain a target paragraph included in the document, and outputting the document in response to an input of a user, based on a feature vector of the target paragraph and the input of the user.

In some implementations, the storing of the document, the metadata of the document, and the classification information of the document can include determining the classification information, based on an object identified from contents included in the document and an action corresponding to the object, identifying the metadata, including description information of the document, from a server in which the document is stored, and storing the document, the metadata, and the classification information in a database for storing data with the identifier as the primary key.

In some implementations, the obtaining of the target paragraph included in the document can include applying the regular expression to the document to identify a target section included in the document and about an abstract of the document or contents included in the document and obtaining the feature vector of the target paragraph, based on that a paragraph corresponding to the target section is the target paragraph.

In some implementations, the method can further include receiving the input of the user, the input including object classification information, a question, and a search weight, from the user.

In some implementations, the receiving of the input of the user can include identifying a type of the question from the input of the user and determining whether the question included in the input of the user is an academic question.

In some implementations, the outputting of the document can include determining at least one large language model (LLM) output generated from an LLM as an output corresponding to the input of the user.

In some implementations, the outputting of the document can include obtaining a comparison vector about a feature of the question, based on that the question is the academic question and that the object classification information and the classification information of the document are the same as each other.

In some implementations, the outputting of the document can include identifying at least one elementary vector from a vector store in which the feature vector is stored, determining a similarity of each of the at least one elementary vector, based on comparison between the comparison vector and the at least one elementary vector, and outputting the document in response to the input of the user, based on that a vector with a highest similarity among the at least one elementary vector is the feature vector.

In some implementations, the outputting of the document can include applying the search weight to the similarity of each of the at least one elementary vector and outputting the document in response to the input of the user, based on the similarity of each of the at least one elementary vector, the similarity to which the search weight is applied.

In some implementations, the method can further include obtaining a rouge score about at least one LLM output obtained by applying a question included in the input of the user to an LLM, based on that the document is determined as an output corresponding to the input of the user, and performing comparison between the rouge score and a predetermined value to verify validation of the output.

### BRIEF DESCRIPTION OF THE DRAWINGS

FIG. 1 is a diagram illustrating a block diagram of an example of an electronic device.

FIG. 2 is a flowchart for describing an example of a method for determining an output corresponding to an input of a user.

FIG. 3 is a diagram illustrating an example of a database for storing classification information, metadata, and a document.

FIG. 4 is a diagram illustrating an example of an interface for receiving an input of a user.

FIG. 5 is a diagram illustrating an example of an interface for providing an output corresponding to an input of a user.

FIG. 6 is a flowchart for describing an example of a method for providing an output corresponding to an input of a user.

FIG. 7 is a diagram illustrating an example of a computing system associated with an electronic device and a method for providing information in the electronic device.

### DETAILED DESCRIPTION

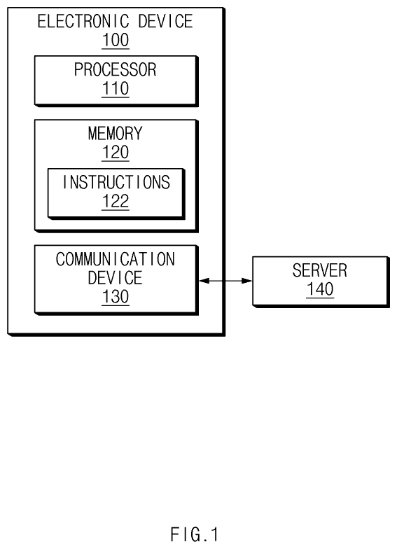

Hereinafter, the present disclosure will be described in detail with reference to FIGS. 1 to 7.

FIG. 1 is a diagram illustrating a block diagram of an example of an electronic device.

An electronic device 100 can include a processor 110, a memory 120 including instructions 122, and a communication device 130.

The electronic device 100 can indicate a device for determining an output corresponding to an input of a user. For example, the electronic device 100 can receive an input regarding a question, such as “what are the key findings regarding the influence of inlet velocity, volume fraction, and flow direction of nanofluids on thermal management of battery modules? ”, from the user. The electronic device 100 can preprocess documents or data to determine an output corresponding to the question. For example, the electronic device 100 can store documents or data in a database depending on a category of each of the documents. In some implementations, the category can indicate classification information of the document. The electronic device 100 can store a feature vector of each of the stored documents in the database. The electronic device 100 can store the documents and the feature vector of each of the documents to preprocess the documents.

The electronic device 100 can compare the category of the question with the category of each of the documents stored in the database. If a document with the same category as the category of the question is identified, the electronic device 100 can perform the following operation. The electronic device 100 can compare the feature vector of each of the documents with the question to determine the output corresponding to the question. For example, the electronic device 100 can determine a similarity between the feature vector of each of the documents and the question. The electronic device 100 can determine a document with a highest similarity among the documents as the output corresponding to the question. The electronic device 100 can provide, on an interface, contents included in the document determined as the output to be conveniently identified by the user.

The electronic device 100 can apply the question to a large language model (LLM) to obtain an LLM output. The electronic device 100 can compare the LLM output with the document determined as the output. The electronic device 100 can verify validation of the document determined as the output, based on a result of the comparison.

The electronic device 100 can present an answer, which is the output corresponding to the question, throughout two stages, using specialized information suitable for a domain, thus enabling the user to identify a specific solution to a problem, an experimental result, numerical information, and the like. The electronic device 100 can present the user with original data used to generate an answer and provide the user with a summary, a source, and bibliographic information for the original data together, through an interface, thus easily verifying hallucination.

The processor 110 can execute software and control at least one other component (e.g., a hardware or software component) connected with the processor 110. In addition, the processor 110 can perform a variety of data processing or computation. For example, the processor 110 can store the document, the input of the user, the output, or the like in the memory 120.

In some implementations, the processor 110 can perform all operations performed by the electronic device 100. To simplify the description in this specification, the operations of the electronic device 100 are primarily attributed to the processor 110.

In some implementations, the electronic device 100 can include at least one processor. Each of the at least one processor can perform all operations associated with an operation of determining the output corresponding to the input of the user.

The memory 120 can temporarily and/or permanently store various pieces of data and/or information required to perform the operation of determining the output corresponding to the input of the user. For example, the memory 120 can store the document, the input of the user, the output, or the like.

The communication device 130 can enable performing communication between the electronic device 100 and the server 140. For example, the communication device 130 can include one or more components for performing communication between the electronic device 100 and the server 140. In some implementations, the communication device 130 can include a short range wireless communication unit, a microphone, or the like. For example, a short range communication technology may be, but is not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like.

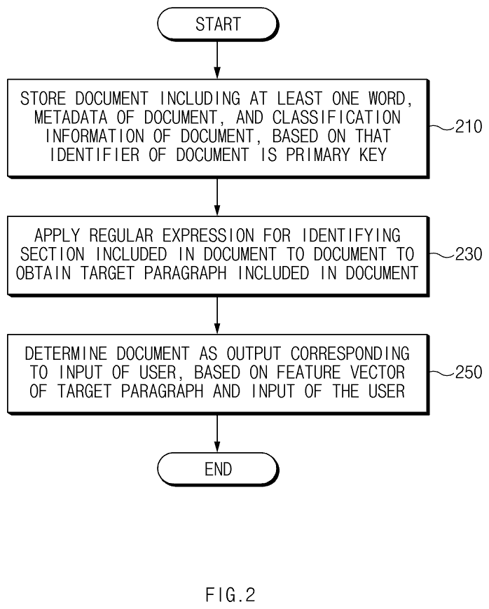

FIG. 2 is a flowchart for describing an example of a method for determining an output corresponding to an input of a user.

In operation 210, a processor (e.g., a processor 110 of FIG. 1) can store a document including at least one word, metadata of the document, and classification information of the document, based on that an identifier of the document is a primary key.

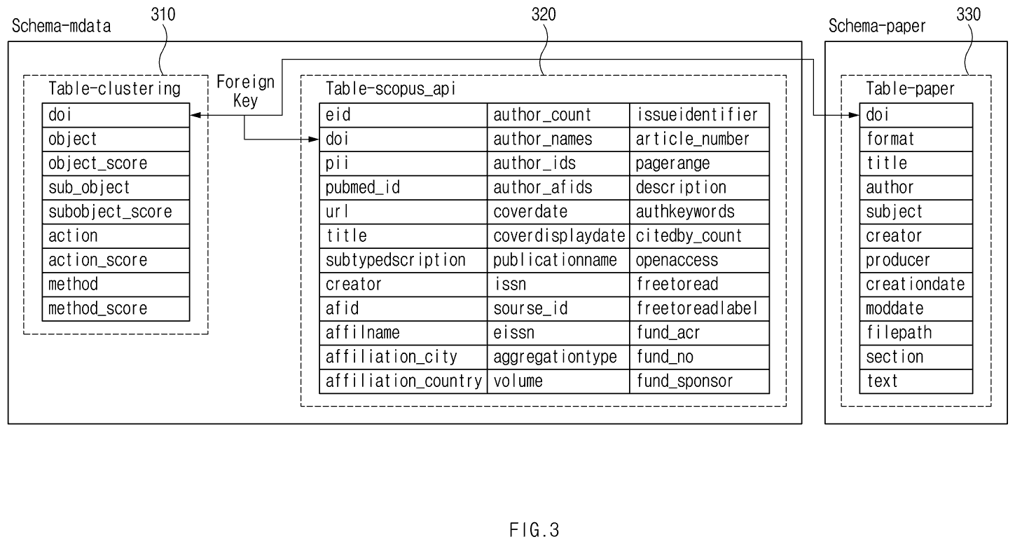

For example, the document can include data such as a research paper incorporating a problem definition, a solution, an experimental result, or the like for an engineering problem, a patent, a source code, or technology trend information. The metadata of the document can include description information about the document, such as academic data. The classification information of the document can be a system for classifying the document such as the academic data, which can be composed of an object and an action. For example, for a document related to battery life prediction, the classification information can be composed of an object (e.g., a battery) and an action (e.g., life prediction). The processor can configure metadata, a research paper, and classification information in the form of one document using a primary key. In some implementations, the identifier used as the primary key can be a digital object identifier (DOI). The description of the metadata, the research paper, and the classification information configured in the form of the document will be provided below with respect to FIG. 3.

In operation 230, the processor can apply, to the document, a regular expression for identifying a section included in the document to thereby obtain a target paragraph included in the document. For example, the processor can divide sections of the document using the regular expression and extract text for each section.

For reference, to simplify description in this specification, it is described that the processor obtains one target paragraph included in the document, but not limited thereto. For example, the processor can apply the regular expression to the document to obtain at least one paragraph. By way of further example, the processor can apply the regular expression to the document to identify an abstract section, an introduction section, a methods section, and a conclusions section.

The processor can extract pieces of text included in each of the identified sections. For example, the pieces of text included in the identified section can refer to a paragraph. The target paragraph can include, but is not limited to, pieces of text included in the abstract section. For example, the target paragraph can include pieces of text included in at least one of the abstract section, the introduction section, the methods section, or the conclusions section, or any combination thereof.

In operation 250, the processor can determine the document as an output corresponding to an input of a user, based on a feature vector of the target paragraph and the input of the user. For example, the processor can segment the pieces of text included in the target paragraph (e.g., the abstract section or the abstract section and the introduction section) depending on a predetermined length.

The processor can apply the pieces of segmented text to a vectorization model to obtain the feature vector. For example, the processor can apply the pieces of segmented text to the vectorization model to obtain the feature vector every pieces of segmented text. By way of further example, if the target paragraph includes 100 words and the predetermined length is 25 words, the processor can segment the pieces of text included in the target paragraph into 4 groups. Thereafter, the processor can apply each of the 4 groups to the vectorization model to obtain 4 feature vectors.

For example, if words included in one group are “I”, “love”, and “you”, the feature vector can include an abstracted value corresponding to “I”, an abstracted value corresponding to “love”, and an abstracted value corresponding to “you”.

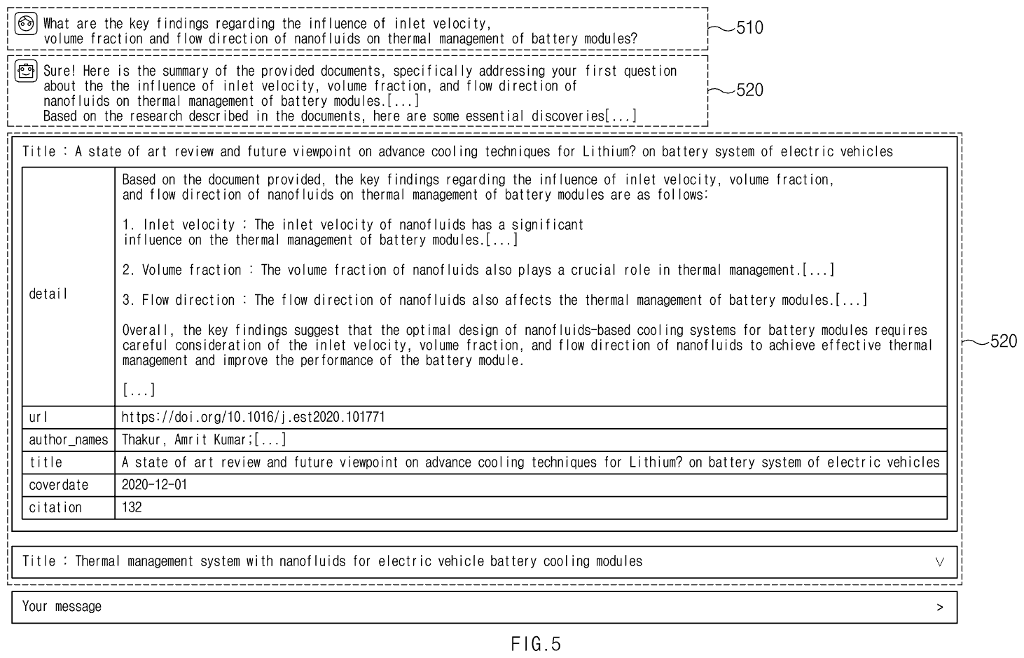

The input of the user can include object classification information, a question, and a search weight. For example, in the step of setting classification suitable for the question, the processor can receive object classification information including an object and an action to be performed. Depending on whether the user selects both the object and the action, only the object, only the action, or neither, contents of an answer may vary. As the range of utilization data changes, the accuracy and reliability of the answer can improve with more specific classification settings. The search weight can refer to a weight applied to answers determined according to the object classification information and the question. A detailed description of the weight will be provided below with respect to FIG. 5.

FIG. 3 is a diagram illustrating an example of a database for storing classification information, metadata, and a document.

A processor (e.g., a processor 110 of FIG. 1) can determine classification information 310, based on an object identified from contents included in a document 330 and an action corresponding to the object. The processor can identify metadata 320 including description information of the document 330 from a server (e.g., a server 140 of FIG. 1) in which the document 330 is stored. The processor can store the document 330, the metadata 320, and the classification information 310 in a database configured to store data with an identifier as a primary key. In some implementations, the document 330 can be a research paper.

For example, the processor can access a site (e.g., an website) to identify an electric vehicle (EV)-related research paper, based on a search formula of <(vehicle OR automotive) AND (“electric vehicle” OR “hybrid vehicle” OR “battery electric vehicle” OR “solid state battery”)>. The processor can identify the metadata 320 in the form of a comma-separated values (csv) file, through an API. The processor can apply a regular expression to the research paper to distinguish sections and extract text for each section. The processor can determine classification information of research paper data, based on the object and the action. For example, the processor can classify a research paper regarding life prediction (e.g., an action) of a battery (e.g., an object) into one category.

The processor can enable searching all documents for a research paper which does not belong to the category through an “All” option. For example, if a user wants to learn about battery-swapping technology but there is no specific action category, they may select “ALL” and perform a search. Based on such a classification system, the processor can match each of pieces of abstract information with the classification system, using an open-source classification model. Such classification information can be applied to all pieces of research paper data in the same manner.

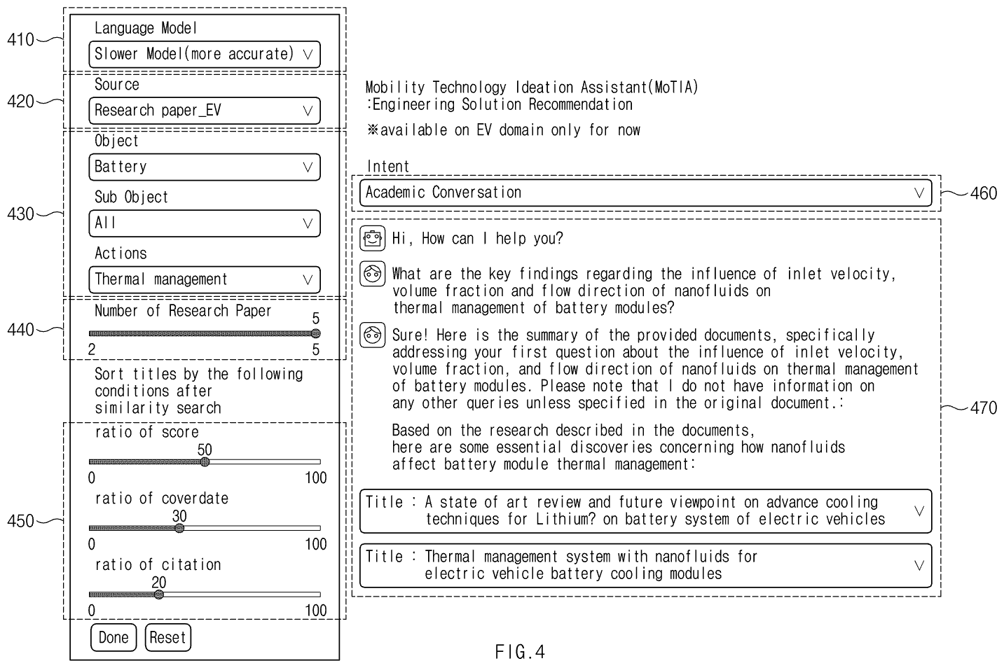

FIG. 4 is a diagram illustrating an example of an interface for receiving an input of a user.

If executing a program including a code or instructions for performing an operation of FIG. 2, a processor (e.g., a processor 110 of FIG. 1) can provide a user with an interface shown in FIG. 4.

The user can set a parameter for obtaining an optimal answer, before inputting a prompt. An interface for setting a parameter can be the interface shown in FIG. 4.

The processor can receive, from the user, an input of the user, which includes object classification information, a question, and a search weight. For example, the user can select a model for generating an answer, through a language model selection menu 410.

In some implementations, a language model can provide a probability value based on a connection relationship between words. The language model can provide a probability value for a next word to be connected with a word which is input using a recognition function of a neural network. For example, if the word of “A” is input to the language model, the language model can determine values of a probability that “B” or “C” will be connected subsequently to “A”. The language model can include a hierarchical structure. For example, the language model can include a recurrent neural network (RNN).

The user can select a database to refer to generation of an answer, through a database selection menu 420. The processor can search for documents, based on the database selected by the user.

The user can input object classification information, through an object classification information selection menu 430. The processor can search for documents, based on object classification information input by the user.

The user can select a maximum research paper number to use to generate an answer, through a research paper number selection bar 440. The processor can determine the number of documents provided as an output to the user among the found documents, based on the selection of the research paper number of the user.

The user can select criteria for research paper selection, through a search weight selection bar 450. The processor can perform operations which will be described below with respect to FIG. 5, based on the search weight setting of the user.

The user can select whether the question of the user is an academic question, through an academic question selection menu 460. For example, the processor can determine whether the question included in the input of the user is an academic question, based on the selection of the user.

The processor can apply the question included in the input of the user to a large language model (LLM), based on that the question is different from the academic question or the object classification information and the classification information of the document are different from each other. For example, if all of pieces of classification information of documents stored in the database selected by the user are different from the object classification information, the processor can apply the question to the LLM.

The processor can determine at least one LLM output generated from the LLM, rather than the document, as an output corresponding to the input of the user. The processor can provide the user with the at least one LLM output generated from the LLM, through an output window 470.

After performing the operations described in FIG. 2, the processor can receive the input of the user, which is described in FIG. 4. The processor can apply a question included in the input of the user, rather than the document stored in FIG. 2, to the LLM, based on that the question is different from the academic question or the object classification information and the classification information of the document are different from each other, from the input of the user. In some implementations, the processor can perform operations which will be described below with respect to FIG. 5, based on that the question is the same as the academic question and the object classification information and the classification information of the document are the same as each other, from the input of the user.

FIG. 5 is a diagram illustrating an example of an interface for providing an output corresponding to an input of a user.

If executing a program including a code or instructions for performing an operation of FIG. 2, a processor (e.g., a processor 110 of FIG. 1) can provide a user with an interface shown in FIG. 5.

The user can input a question among user inputs, through a question input window 510. For example, the user can input “a prompt on battery thermal management of electric vehicles and What are the key findings regarding the influence of inlet velocity, volume fraction, and flow direction of nanofluids on thermal management of battery modules? ”through the question input window 510.

The processor can obtain a comparison vector regarding a feature of the question, based on that the question is an academic question and object classification information and classification information of a document are identical.

The processor can identify at least one elementary vector from a vector store, where the vector store is configured to store the feature vector. For example, the at least one elementary vector can include the feature vector.

The processor can determine a similarity of each of the at least one elementary vector, based on comparison between the comparison vector and the at least one elementary vector. For example, if the at least one elementary vector includes a first elementary vector and a second elementary vector, the processor can determine a similarity of the first elementary vector, based on comparison (e.g., a cosine similarity) between the comparison vector and the first elementary vector. The processor can determine a similarity of the second elementary vector, based on comparison between the comparison vector and the second elementary vector.

The processor can output a document in response to the input of the user, based on that a vector with a highest similarity among the at least one elementary vector is a feature vector. For example, the document can indicate a document including a target paragraph. However, the operation of outputting the document in response to the input of the user is not limited thereto. The processor can output a document corresponding to the vector with the highest similarity among the at least one elementary vector (e.g., a document different from the document including the target paragraph about the feature vector) in response to the input of the user.

In some implementations, the processor can apply a search weight to the similarity of each of the at least one elementary vector. The search weight can include factors such as a publication date of the document, the recency of the data, and the number of citations, with higher weights assigned to more impactful data. For example, if the at least one elementary vector includes the first elementary vector and the second elementary vector, the processor can apply a search weight (e.g., a weight about a publication date of a first document corresponding to the first elementary vector and citations of the first document) to the first elementary vector and apply a search weight (e.g., a weight about a publication date of a second document corresponding to the second elementary vector and citations of the second document) to the second elementary vector.

The processor can output the document in response to the input of the user, based on a similarity of each of the at least one elementary vector to which the search weight is applied.

The processor can apply the determined document to an LLM to obtain at least one LLM output (e.g., a summary of the document). For example, the processor can generate a summary of the document. The summary of the document can include contents included in results and conclusions sections for a research paper and include contents included in detailed contents, implementations, and claims of the invention for a patent document. The processor can apply the determined document to the LLM to provide at least one LLM output through an output providing window 520.

The processor can obtain a rouge score related to whether at least one LLM output obtained by applying a question included in the input of the user to the LLM and the document are identical to each other, based on that the determined document is determined as an output corresponding to the input of the user. The processor can compare the rouge score with a predetermined score to verify validation of the output. Furthermore, the processor can verify the validation of the output, based on evaluation and/or feedback of the user.

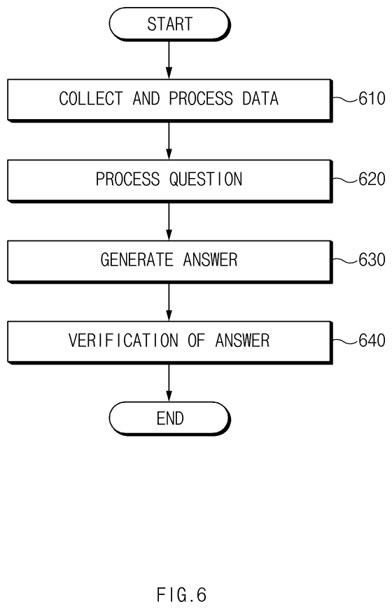

FIG. 6 is a flowchart for describing an example of a method for providing an output corresponding to an input of a user.

In operation 610, a processor (e.g., a processor 110 of FIG. 1) can collect and process data. For example, the processor can collect academic data. The academic data can include structured and unstructured data such as a research paper, a patent, a source code, and technology trend information. The processor can determine classification information of the academic data.

After determining the classification information, the processor can generate metadata which is description information about the academic data. The processor can store the academic data, the classification information, and the metadata in a database configured to store data with an identifier as a primary key.

The processor can divide text for each area. For example, the processor can apply a regular expression to the academic data to thereby identify an area and/or a section included in the academic data. The processor can segment pieces of text included in the identified area and/or section into an optimal length and transform the pieces of segmented text into a vector. The processor can store the pieces of transformed vectors in a vector store.

In operation 620, the processor can process a question. For example, a user can select an object and an action to input object classification information. As a result, as specificity of the selection is reinforced, accuracy and reliability of an answer can be improved. The user can input a search weight, as criteria for data ranking selection. The user can perform a prompt input through an interface. For example, the user can input a question as the prompt input. In addition, the user can input whether the question input as the prompt is an academic question. The processor can search for and select related data, based on the input of the user, which is described above.

In operation 630, the processor can generate an answer. For example, the processor can determine rankings of documents, depending on the object classification information and the search weight, which are input by the user. The operation of determining the rankings of the documents may be the same as the operation described above in FIG. 5.

In operation 640, the processor can perform verification of the answer. For example, the verification of the answer can include a quantitative method and a qualitative method. By way of further example, the quantitative method can be performed, based on a rouge score about whether at least one LLM output obtained by applying a question included in an input of the user to an LLM and a document are identical to each other. The qualitative method can be performed, based on a method for reviewing an answer of the user and a method for correcting a system prompt in which feedback is reflected.

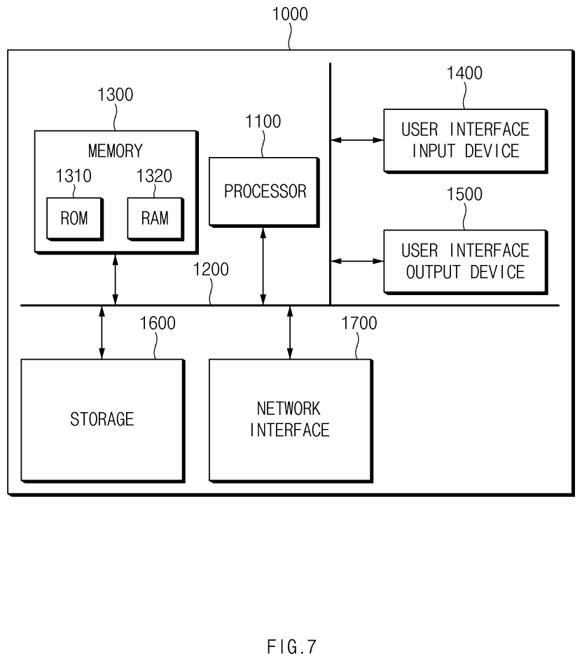

FIG. 7 is a diagram illustrating an example of a computing system associated with an electronic device and a method for providing information in the electronic device.

Referring to FIG. 7, a computing system 1000 about the electronic device and the method for providing the information in the electronic device can include at least one processor 1100, a memory 1300, a user interface input device 1400, a user interface output device 1500, a storage 1600, and a network interface 1700, which are connected with each other via a bus 1200.

The processor 1100 can be a central processing unit (CPU) or a semiconductor device that processes instructions stored in the memory 1300 and/or the storage 1600. The memory 1300 and the storage 1600 can include various types of volatile or non-volatile storage media. For example, the memory 1300 may include a ROM (Read Only Memory) 1310 and a RAM (Random Access Memory) 1320.

Accordingly, the operations of the method or algorithm described in the specification can be directly implemented with a hardware module, a software module, or a combination of the hardware module and the software module, which is executed by the processor 1100. The software module can reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium can be coupled to the processor 1100. The processor 1100 can read out information from the storage medium and may write information in the storage medium. Alternatively, the storage medium can be integrated with the processor 1100. The processor and the storage medium can reside in an application specific integrated circuit (ASIC). The ASIC can reside within a user terminal. In another case, the processor and the storage medium can reside in the user terminal as separate components.

The above-described implementations can be implemented with hardware components, software components, and/or a combination of hardware components and software components. For example, the devices, methods, and components described in the implementations can be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit can perform an operating system (OS) or a software application running on the OS. Further, the processing unit can access, store, manipulate, process and generate data in response to execution of software. It will be understood by those skilled in the art that although a single processing unit can be illustrated for convenience of understanding, the processing unit can include a plurality of processing elements and/or a plurality of types of processing elements. For example, the processing unit can include a plurality of processors or one processor and one controller. Also, the processing unit can have a different processing configuration, such as a parallel processor.

Software can include computer programs, codes, instructions or one or more combinations thereof and can configure a processing unit to operate in a desired manner or can independently or collectively instruct the processing unit. Software and/or data can be permanently or temporarily implemented in any type of machine, component, physical equipment, virtual equipment, computer storage medium or unit or transmitted signal waves so as to be interpreted by the processing unit or to provide instructions or data to the processing unit. Software can be dispersed throughout computer systems connected over networks and be stored or executed in a dispersion manner. Software and data can be recorded in one computer-readable storage media.

The methods described above can be implemented in the form of program instructions which may be executed through various computer means and can be recorded in computer-readable media. The computer-readable media can include program instructions, data files, data structures, and the like alone or in combination, and the program instructions recorded on the media can be specially designed and configured for an example or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Examples of computer programs include not only machine language codes created by a compiler, but also high-level language codes that are capable of being executed by a computer by using an interpreter or the like.

The above-described hardware devices can be configured to act as one or a plurality of software modules to perform the operations of the implementations, or vice versa.

According to at least one of implementations of the present disclosure, the electronic device can store metadata of a document and classification information of the document in a database on the basis of an identifier of the document, thus providing an answer including the most recent information based on information included in the database, without additional training of a large language model, which requires huge cost and time.

Furthermore, according to at least one of implementations of the present disclosure, the electronic device can determine classification information, based on an object identified from contents included in the document and an action corresponding to the object, thus reducing hallucination to increase reliability of an answer and providing an answer which is easy to compare other types of technologies for the same purpose in the same technology field.

What is claimed is:

1. An electronic device comprising:
a memory storing computer-executable instructions; and
at least one processor configured to access the memory and execute the instructions to perform operations comprising:
storing, based on an identifier of a document being a primary key, the document including at least one word, metadata of the document, and classification information of the document;
applying, to the document, a regular expression for identifying a section in the document to thereby obtain a target paragraph in the document; and
outputting, based on an input being received, the document based on the received input and a feature vector of the target paragraph and the received input.

2. The electronic device of claim 1, wherein storing the document, the metadata, and the classification information comprises:
determining the classification information based on (i) an object identified from contents included in the document and (ii) an action corresponding to the object;
identifying, from a server configured to store the document, the metadata including description information of the document; and
storing the document, the metadata, and the classification information in a database, the database being configured to store the identifier as the primary key.

3. The electronic device of claim 1, wherein obtaining the target paragraph comprises:
applying the regular expression to the document to thereby identify a target section that is included in the document and that is associated with an abstract of the document or contents included in the document; and
obtaining the feature vector of the target paragraph based on a paragraph corresponding to the target section being the target paragraph.

4. The electronic device of claim 1, wherein the operations further comprise:
receiving, from a user device, the input including at least one of object classification information, a question, or a search weight.

5. The electronic device of claim 4, wherein receiving the input comprises:
identifying a type of the question from the received input; and
determining whether the question is an academic question.

6. The electronic device of claim 5, wherein outputting the document comprises:
determining at least one large language model (LLM) output generated from an LLM as an output corresponding to the received input.

7. The electronic device of claim 5, wherein outputting the document comprises:
obtaining, based on the question being the academic question and the object classification information and the classification information of the document being identical, a comparison vector regarding a feature of the question.

8. The electronic device of claim 7, wherein outputting the document comprises:
identifying at least one elementary vector from a vector store, the vector store being configured to store the feature vector;
determining a similarity of each elementary vector based on a comparison between the comparison vector and the at least one elementary vector; and
outputting, based on the input being received, the document based on a vector with a highest similarity among the at least one elementary vector being the feature vector.

9. The electronic device of claim 8, wherein outputting the document comprises:
applying the search weight to the similarity of each elementary vector; and
outputting, based on the input being received, the document based on the similarity to which the search weight is applied.

10. The electronic device of claim 1, wherein the operations further comprise:
obtaining a rouge score regarding at least one LLM output obtained by applying a question included in the received input to an LLM based on a determination that the document is an output corresponding to the received input; and
performing a comparison between the rouge score and a predetermined value to thereby verify validation of the output.

11. A method comprising:
storing, based on an identifier of a document being a primary key, the document including at least one word, metadata of the document, and classification information of the document;
applying, to the document, a regular expression for identifying a section in the document to thereby obtain a target paragraph in the document; and
outputting, based on an input being received, the document based on a feature vector of the target paragraph and the received input.

12. The method of claim 11, wherein storing the document, the metadata, and the classification information comprises:
determining the classification information based on (i) an object identified from contents included in the document and (ii) an action corresponding to the object;
identifying, from a server configured to store the document, the metadata including description information of the document; and
storing the document, the metadata, and the classification information in a database, the database being configured to store the identifier as the primary key.

13. The method of claim 11, wherein obtaining the target paragraph comprises:
applying the regular expression to the document to thereby identify a target section that is included in the document and that is associated with an abstract of the document or contents included in the document; and
obtaining the feature vector of the target paragraph based on a paragraph corresponding to the target section being the target paragraph.

14. The method of claim 11, further comprising:
receiving, from a user device, the input including at least one of object classification information, a question, or a search weight.

15. The method of claim 14, wherein receiving the input comprises:
identifying a type of the question from the received input; and
determining whether the question is an academic question.

16. The method of claim 15, wherein outputting the document comprises:
determining at least one large language model (LLM) output generated from an LLM as an output corresponding to the received input.

17. The method of claim 15, wherein outputting the document comprises:
obtaining, based on the question being the academic question and the object classification information and the classification information of the document being identical, a comparison vector regarding a feature of the question.

18. The method of claim 17, wherein outputting the document comprises:
identifying at least one elementary vector from a vector store, the vector store being configured to store the feature vector;
determining a similarity of each elementary vector based on a comparison between the comparison vector and the at least one elementary vector; and
outputting, based on the input being received, the document based on a vector with a highest similarity among the at least one elementary vector being the feature vector.

19. The method of claim 18, wherein outputting the document comprises:
applying the search weight to the similarity of each elementary vector; and
outputting, based on the input being received, the document based on the similarity to which the search weight is applied.

20. The method of claim 11, further comprising:
obtaining a rouge score regarding at least one LLM output obtained by applying a question included in the received input to an LLM based on a determination that the document is an output corresponding to the received input; and
performing a comparison between the rouge score and a predetermined value to thereby verify validation of the output.
